(19) United States
(12) Patent Application Publication
(10) Pub. No.: US 2008/0282589 A1
(43) Pub. Date: Nov. 20, 2008

(54) Billboard System

(76) Inventor: Sergey Joukov, Zoran (IL)

Correspondence Address: YORAM TSIVION, P.O. BOX 1307, PARDES HANNA, 37111, IL

(21) Appl. No.: 12/092,080

(22) PCT Filed: Oct. 31, 2005
(86) PCT No.: PCT/IL05/01137

§ 371 Date: Apr. 30, 2008

(51) Int. Cl. G09F 11/02

(52) U.S. Cl. 40/505; 40/504

(57) ABSTRACT

A billboard with rotating parts holding parts of ads to be displayed, includes motors (13) for switching between the two sides of the billboard by their rotation. Each side of the billboard includes three-sided panels (11), each side represents parts of an ad, so that each side of the billboard may present up to three ads. Each several adjacent panels and the same number of parallel panels behind them at the other side, belong to one two-sided part (10), which is capable of rotating by 180 degrees without bumping into adjacent parts, to switch between up to six different ads altogether. A motor (13) is used to rotate the billboard parts.

### FIELD OF THE INVENTION

This invention relates to billboards, and more particularly to a billboard capable of presenting up to six different posters or ads.

### BACKGROUND OF THE INVENTION

Billboards are in a common use around the world, especially outdoors, such as on highways and near crowded areas, but also indoors, such as in malls and other urban areas.

There is a need to show several ads on the same billboard for many reasons, including for example:

1. It is expensive to change the ads—each time, this requires workers and resources. The ads are usually located in higher, difficult to access locations. It may be preferable not to replace the ads too often, or, if the ads need be replaced anyway—to replace several ads a time.
2. Changing ads are more effective in attracting the attention of passers-by. Changing ads are more appealing than static ads.
3. Sharing the cost—General lack of space, and the costs and resources associated with each billboard, make it more practical to share the advertising costs among several promoters.

There are various implementations of such billboards. In one embodiment, a mechanical billboard can physically switch between several ads.

There are different ways to implement this, however big outdoors billboards usually display up to three ads on one billboard, by using rotating panels of triangular cross-section.

Each panel is vertical, spanning the whole height of the ad, from top to bottom. Each panel is relatively narrow. All the panels are located close to one another in order to create a smooth appearance of the ad, with a minimal spaces between the panels. One or more engines rotate the panels, each one around its center, to switch between the ads.

It is possible, using this approach, to present up to three ads by using panels with three sides. It is not practical to use more than three sides, as adjacent panels would collide with each other, and could not rotate as desired.

Other implementations in use today include electronic billboards, which can show many different ads, however they are very expensive, require electronic components and consume a lot of power. They are more difficult to fix and maintain. In addition, during daytime, ads on these billboards might not be visible as clearly as regular billboards, whereas at night they might distract drivers.

### SUMMARY OF THE INVENTION

The present disclosure relates to an improved billboard of the mechanical variety, which is capable of physically displaying up to six different ads.

The billboard includes two or more three-sided elements mounted on a common plane and including means for their rotation together. Each element has a prism-like shape with an equilateral triangle cross-section.

This new structure allows to place the elements close to each other so as to display one virtually contiguous surface, and also for each element to rotate without bumping into the adjacent elements.

As the elements are rotated together to display one of their three sides, three distinct ads may be displayed.

Using a two-sided structure with an array of rotating elements on each side, up to six distinct ads may be displayed.

Thus, the new billboard is capable of switching between up to six posters or ads—having three different ads on each side, times two sides. The system is switching both the panels and the sides, as desired.

The new billboard offers many benefits, including for example:

1. Having six ads saves workhours and resources. More ads can be replaced at the same time, and the schedule of replacing them can be further delayed if most of the ads are still relevant. The new billboard may be optionally capable of skipping irrelevant ads and still showing others.
2. Not replacing ads too often increases road security, reducing interference to traffic, and contributes to the security of workers, who are required to maintain the billboards on less frequent occasions.
3. The observers of the ads will see a larger variety of ads, six ads may be especially useful for showing a different ad for each time of the week, for instance (it happens to correspond to six workdays).
4. Obsolete ads or ads which are no longer sponsored, can be optionally skipped, saving the need to immediately replace them, and still showing a reasonable number of other ads.
5. Using the new billboard, it possible to reduce costs and the use of resources, using less billboards each with more ads. The new billboard increases the diversity of billboards with only three panels, by 100 percent.

The new billboard can utilize components of existing three-sided-panel billboards: these devices already have at least one electric engine within, in order to rotate the panels and switch between the ads. These engines may be used to rotate the two sided parts as well, enabling to achieve the new billboard by using the same engines, making the new billboards not much expensive than traditional three sided panels billboards.

Each two-sided part may have similar identical panels on each side. Preferably, the parts are identical for simplicity in manufacturing and maintenance.

Further objects, advantages and other features of the present invention will become obvious to those skilled in the art upon reading the disclosure set forth hereinafter.

### BRIEF DESCRIPTION OF THE DRAWINGS

FIG. 1 illustrates a top view of the billboard

FIG. 2 illustrates a front view of the billboard

FIG. 3 illustrates a top view of the structure and method of rotation of the two-sided parts of the billboard

FIG. 4 details a bottom view of the two-sided billboard

FIG. 5 details the mechanism for concurrently rotating the elements of the billboard

FIG. 6 details a front view of a two-side billboard with three elements on each side

### DETAILED DESCRIPTION OF THE PREFERRED EMBODIMENTS

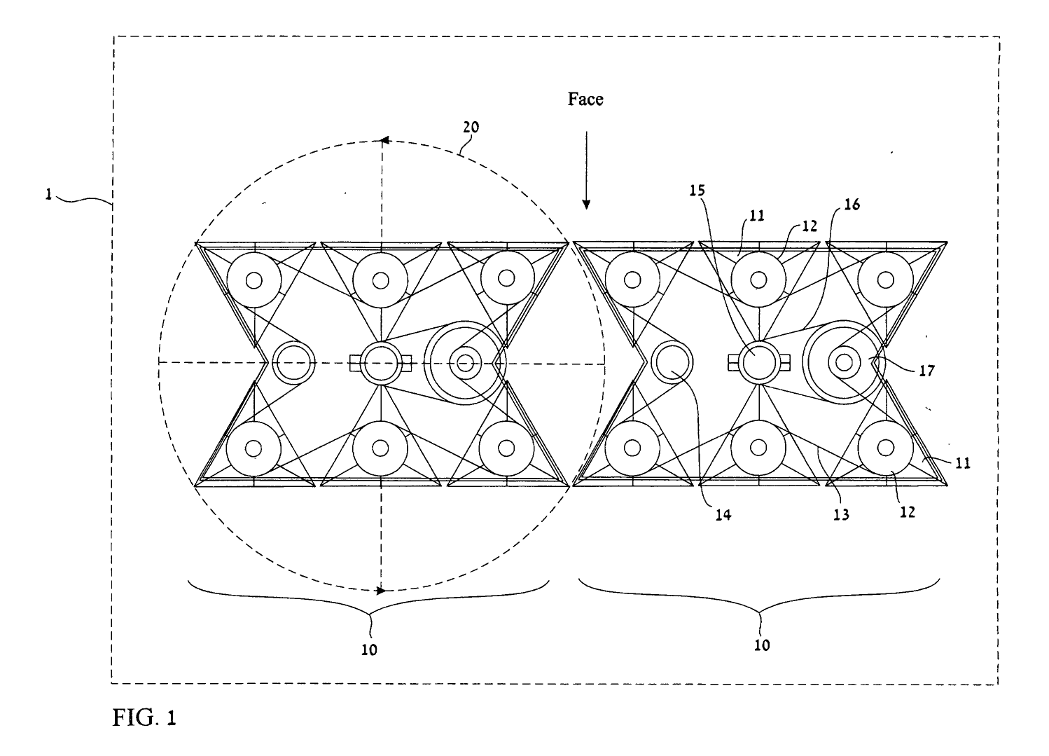

A preferred embodiment of the present invention will now be described by way of example and with reference to the accompanying drawings. FIG. 1 illustrates a top view of the billboard with its two-sided parts.

The billboard includes two or more three-sided elements 11 mounted on a common plane and including means 12 for their rotation together. Each element has a prism-like shape with an equilateral triangle cross-section.

This new structure allows to place the elements close to each other so as to display one virtually contiguous surface, and also for each element to rotate without bumping into the adjacent elements.

The new billboard 1 includes several two-sided rotating parts 10, which are placed adjacent to each other. In each side of the rotating parts, there are rotating equilateral triangular elements 11, thus the new billboard is capable of switching between up to six posters or ads—it can display up to three different ads on each side, and also may rotate to display its front or back side, for a total of six ads towards the desired destination, referred to as “Face” in FIG. 1.

Thus, each unit 10 comprises six display elements 11. The structure allows to freely rotate each unit 10 provided the adjacent units are stationary. Thus, it is possible to rotate together all the even units while the odd units stand still, then to rotate all the odd units while the even units stand still.

Thus, each of the sides of the billboard can present three different ads, when pointing in the desired direction. Each panel 11 can be rotated around its central axis, using for example a circular part 12 which is connected to each panel at its bottom. This allows a simple rotation of the panel using a belt 13, which is connected to a circular part or sprocket 17.

The belt 13 may be implemented as a chain with rigid metal rings, in order to keep the chain tight, and in order to prevent the chain from moving out of each two-sided part. An additional wheel 14 keeps the chain tight by using a spring which pulls the wheel 14 towards the center of the two sided part, not allowing the chain to loosen.

The whole billboard 1 may be operated by two or more motors or engines. At least two motors are used, one for rotating the odd parts (first, third, etc.), the other motor for rotating the even parts (second, fourth, etc.).

In one embodiment, all the parts are connected to motors 23, 24, which are capable of both rotating the panels 11 of each part, and also rotating the two sided parts 10 around their axes, in order to direct toward the “Face” each of the three additional ads which are at the back. The “Face” is the front of the device, which displays the advertisements to the public.

In one embodiment of the invention, a circular shape 15 is installed at the middle of each rotatable part 10. In this embodiment, the circular shape 15 is connected to the billboard. A belt 16 is connected to a part 17 which causes a rotation of part 10 by 180 degrees (to display the other side) for a rotation of parts 11 by 120 degrees (to display the next picture or ad), and to the circular shape 15, at the center of each two sided part. The panels are rotating by moving the panel's belt 13, which rotates the circular part 12, which are connected to each panel.

Each side of the three sides of the panel is displayed for a fixed amount of time and then the panels 11 rotate 120 degrees, in order to display the next side, simultaneously with rotating the unit 10 by 180 degrees.

The above means 17 are optional, and the panels may be connected directly to the engine, using a belt or other means. The panels may be connected therebetween, and to the engine, by any kind of mechanical means, such as a gear mechanism, straps, rotating bars, driving shafts, etc.

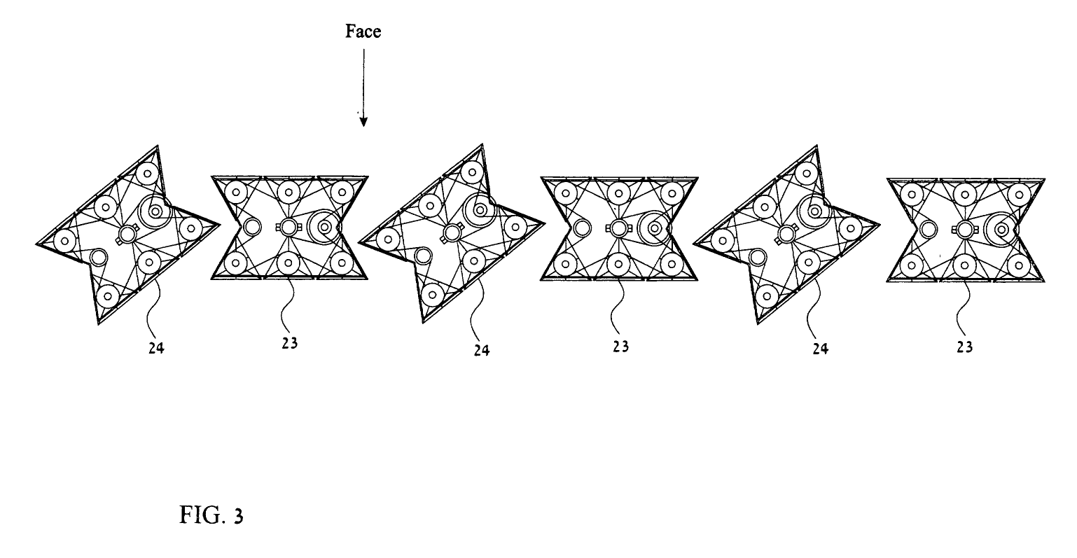

In this embodiment, the engine may also rotate the two-sided part 10, in order to present to “Face” the three other ads which are at the back panels. This rotation 20 of each of the two sided parts is done in a novel approach which shell be described with reference to FIG. 3.

The engine may include an electronic mechanism which controls the operation of the billboard. This electronic control mechanism may include any kind of computer and/or communications means, to allow optional controlling and/or monitoring of the billboard from a remote location.

The electronic mechanism may be very simple, such as a simple electronic circuit or timer which switches between the panels after a fixed time, switches between the two sides of the billboard after another fixed time, and does nothing in between, to allow each ad to be seen for some time.

The electronic mechanism controls the engines or motors, and also may control gears in order to rotate the panels or the two sided parts as required.

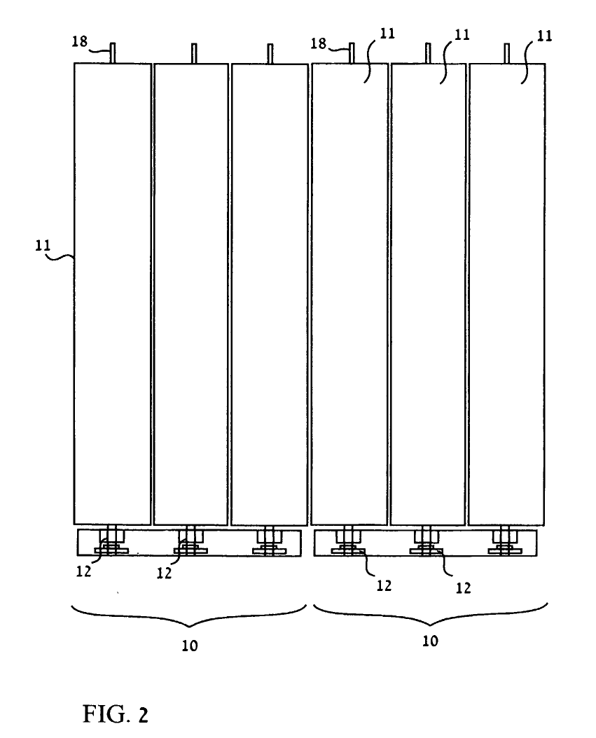

FIG. 2 illustrates a front view of the billboard with its two sided parts. Each two sided part 10, is connected to the billboard from the top, by a rotating hinge 18, allowing the panels to rotate around their axis. Each panel 11 can be rotated around its central axis, by a circular part 12 which is connected to each panel at its bottom.

The circular part 12 may allow separate rotation of the two-sided parts at even locations and those at odd locations, thus preventing adjacent two-sided parts from colliding with each other. Each part 10 may be connected to a separate engine/motor.

In one embodiment, each two-sided part belongs to the odd or even group and adjacent two sided parts do not belong to the same group. Each group is connected to a different driving shaft which is placed at the bottom of the billboard below the two sided parts.

By moving each of the parts by an engine, it is possible to rotate the odd two sided panels and the even two sided panels, separately.

FIG. 3 illustrates a top view of the rotation of the two-sided parts. In one preferred embodiment, each of the two sided parts has three panels on each side placed on the same plane.

Due to the equilateral triangular cross-section of the panels 11, they can rotate around their axis without bumping into each other.

The novel two-sided parts, allow rotation of each two sided part around its axis as well. When the first group 24 of two sided parts are rotating, they will not bump at the parts of the second two sided parts group 23, because of the unique shape of the margins of each two sided part.

A preferred implementation for the rotation of the two sided parts, includes rotating a first group (the odd or the even parts) of the two sided boards for 180 degrees, and then rotating the second group for 180 degrees.

The panels may be rotated by a common mechanism to that which rotates the two sided parts, or by a different mechanism. Any kind of mixture of engines and/or mechanical components may be used in order to implement the novel billboard and to achieve the same result.

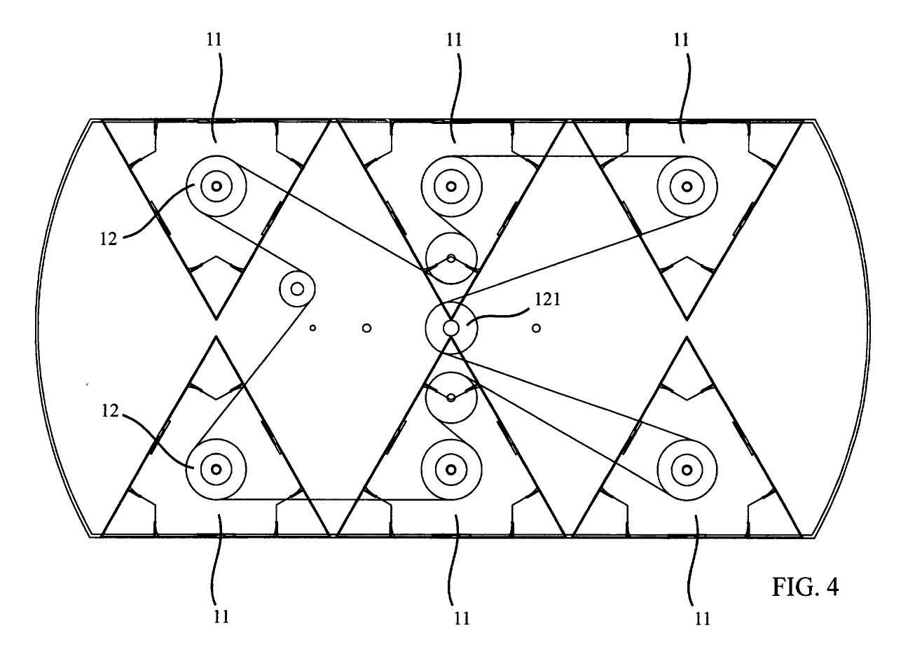

FIG. 4 details a bottom view of the two-sided billboard, in a structure with three rotating elements 11 on each side.

The billboard includes three-sided elements 11 mounted on a common plane and including means for their rotation together. Each element has a prism-like shape with an equilateral triangle cross-section.

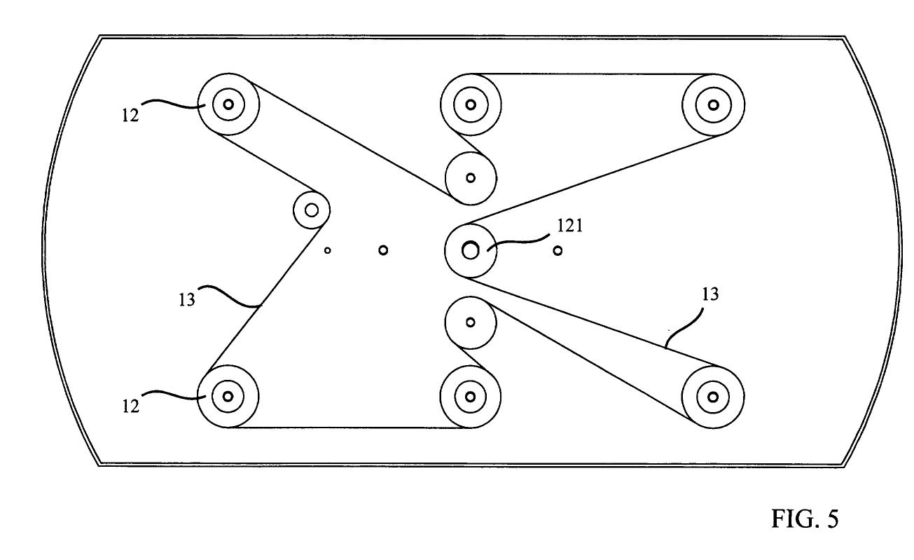

The rotating means may include a wheel or pulley 12 attached to each element. A chain 13 connects all the wheels 12, see FIG. 5. The structure also includes a wheel 121 which is fixed (stator), that is wheel 121 is secured to the ground. As the motor rotates the whole structure (the basis with the rotating elements) by 180 arc degrees, the chain 13 moves to rotate the wheels 12 by 60 arc degrees relative to the structure, so another face of the prism is displayed.

The advantage of the above structure is that one motor may be used to both rotate the three-sided elements with the ads to present, and the structure as a whole.

Other embodiments may be used to perform this task. Basically, a display is made of three-sided rotating elements. For a two-sided display, there are two opposite sides with such rotating elements. Various mechanisms may be used to rotate the elements and the billboard as a whole.

FIG. 5 details one embodiment of a mechanism for concurrently rotating the elements of the billboard, including the chain 13 wrapped about the wheels 12 and the stator 121.

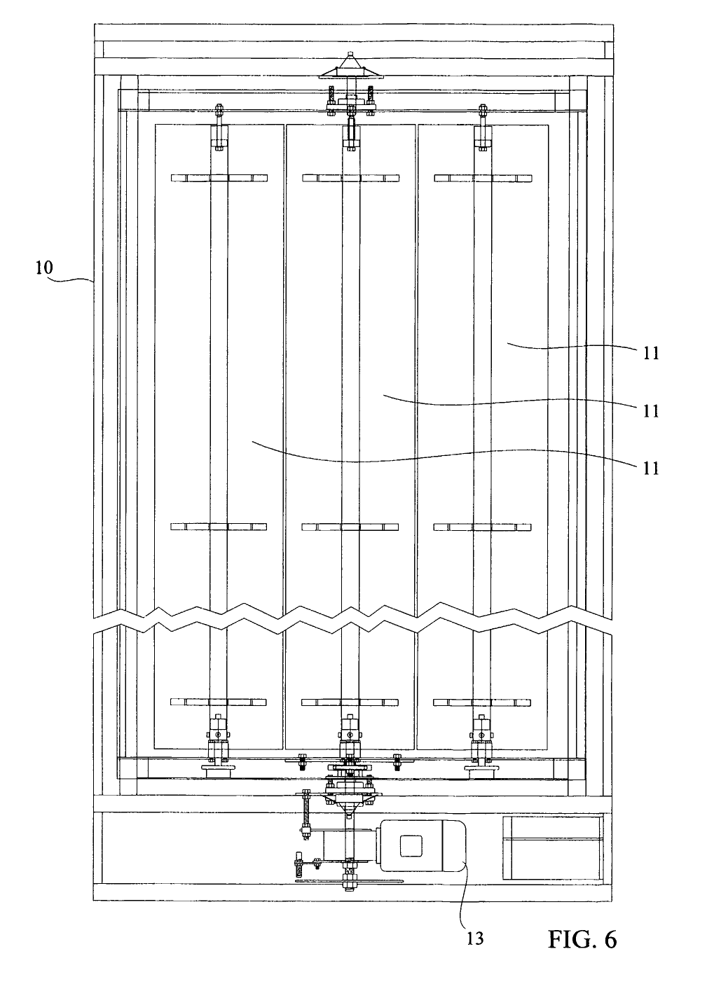

FIG. 6 details a front view of a two-side billboard 10 with three elements 11 on each of its two sides. A motor 13 may be used to rotate the whole structure, by 180 arc degrees each time a different ad is to be displayed.

It will be recognized that the foregoing is but one example of an apparatus and method within the scope of the present invention and that various modifications will occur to those skilled in the art upon reading the disclosure set forth hereinbefore.

What is claimed is:

1. A billboard comprising two or more three-sided elements mounted on a common plane and means for the concurrent rotation of the elements by 60 arc degrees a time, to display one of up to three different ads.

2. The billboard according to claim 1, wherein each element has a prism-like shape with an equilateral triangle cross-section.

3. The billboard according to claim 1, wherein the elements are placed so close to each other as to display one virtually contiguous surface, and also for each element to rotate without bumping into the adjacent elements.

4. A dual-sided billboard comprising two opposite sides with each side comprising two or more three-sided elements mounted on a common plane and means for the concurrent rotation of the elements by 60 arc degrees a time and of the whole billboard by 180 arc degrees, to display one of up to six different ads on each side of the billboard.

5. The billboard according to claim 4, wherein each element has a prism-like shape with an equilateral triangle cross-section.

6. The billboard according to claim 4, wherein the elements are placed so close to each other as to display one virtually contiguous surface, and also for each element to rotate without bumping into the adjacent elements.

7. In a billboard with rotating parts holding parts of ads to be displayed, means for switching between the two sides of the billboard, by rotation.

8. The billboard according to claim 7, wherein each side of the billboard includes three-sided panels, each side represents parts of an ad, so that each side of the billboard may present up to three ads.

9. The billboard according to claim 8, wherein each several adjacent panels and the same number of parallel panels behind them at the other side, belong to one two-sided part, which is capable of rotating by 180 degrees without bumping into other adjacent two-sided parts, allowing to switch between up to six different ads altogether.

10. The billboard according to claim 9, wherein mechanical and/or electrical means placed along the billboard, allow rotating the two-sided parts, without rotating adjacent two-sided parts at the same time.

11. The billboard according to claim 10, wherein mechanical and/or electrical means placed along the billboard, allow rotating the panels, each time by 120 degrees, in order to switch between up to three ads of the panel on each side.

12. The billboard according to claim 9, wherein mechanical and/or electrical means within each two sided part of the billboard, allows rotating the two sided parts, without rotating adjacent two sided parts at the same time.

13. The billboard according to claim 12, wherein mechanical and/or electrical means which are placed along the billboard, allows rotating the panels, each time by 120 degrees, in order to switch between up to three ads of the panel on each side.

14. The billboard according to claim 11, wherein two or more engines which rotate the panels and the two-sided parts further include electronic means for controlling the operation of the billboard, and the electronic means further include computer and/or communications means for controlling and/or monitoring of the billboard from a remote location.

15. The billboard according to claim 11, wherein the panels are connected to the two sided parts, in order to rotate them using the same mechanism, wherein the connection means include belts, gear mechanisms, straps, rotating bars and/or driving shafts.

16. The billboard according to claim 11, wherein each two-sided part includes six panels, three panels on each side and its sides are sunken in order to allow the two sided part to rotate without bumping into adjacent two-sided parts.
